(19) United States
(12) Patent Application Publication
(10) Pub. No.: US 2024/0058978 A1
(43) Pub. Date: Feb. 22, 2024

(54) RAZOR BLADE

(71) Applicant: DORCO CO., LTD., Seoul (KR)

(72) Inventors: Hyun Ju LEE, Seoul (KR); Seung Ki LEE, Seoul (KR); Kwang Choon RYU, Seoul (KR); Min Joo PARK, Seoul (KR)

(21) Appl. No.: 18/447,102

(22) Filed: Aug. 9, 2023

(30) Foreign Application Priority Data
Aug. 16, 2022 (KR) 10-2022-0102298
Jun. 1, 2023 (KR) 10-2023-0071004

(51) Int. Cl. B26B 21/56

(52) U.S. Cl. CPC B26B 21/56

(57) ABSTRACT

A razor blade is proposed. The razor blade may include a substrate having a cutting edge formed at a tip. The substrate may include a plurality of first facets, and a plurality of second facets formed between the tip and the plurality of first facets. The substrate may also include a facet brake region having facet brake spots where the plurality of first facets and the plurality of second facets intersect. The substrate may further include a first facet region including the plurality of first facets but not including the plurality of second facets.

### CROSS-REFERENCE TO RELATED APPLICATIONS

This application claims the benefit of Korean Patent Application Nos. 10-2022-0102298, filed on Aug. 16, 2022, and 10-2023-0071004, filed on Jun. 1, 2023, the contents of each of which are incorporated by reference herein in their entirety.

### BACKGROUND

### Technical Field

The present disclosure relates to a razor blade, and, more particularly, to a razor blade used for cutting hair.

### Description of Related Technology

In the case of a razor blade for cutting hair, such as a beard, varies in shaving performance and shaving feel depending on the shape and material of the blade, which part essentially cuts the hair, causes significant changes in shaving performance and shaving feel, even with a slight difference in shape.

### SUMMARY

One aspect is a razor blade having an optimized profile to lower cutting force of the razor blade and improve bending durability thereof.

Another aspect is a razor blade that provides improved shaving performance and enhanced shaving feeling.

Another aspect is a razor blade with better adhesion between a substrate and a coating layer.

Another aspect is a razor blade including a substrate having a cutting edge formed at a tip, wherein: the substrate includes a plurality of first facets, a plurality of second facets formed between the tip and the plurality of first facets, a facet brake region having facet brake spots where the plurality of first facets and the plurality of second facets intersect, and a first facet region including the plurality of first facets but not including the plurality of second facets; a first thickness T4, which is the thickness of the substrate measured at a distance of 4 μm from the tip, is between 1.40 μm and 1.70 μm; a second thickness T200, which is the thickness of the substrate measured at a distance of 200 μm from the tip, is between 56.50 μm and 64.12 μm; and a ratio (T4/T200) of the first thickness T4 to the second thickness T200 is between 0.022 and 0.030.

Another aspect is a razor blade including a substrate having a cutting edge formed at a tip, wherein: the substrate includes a first facet region including a plurality of first facets formed by first abraded scratches, a plurality of second facets formed by second abraded scratches, and a facet brake region where the first abraded scratches and the second abraded scratches coexist; a first thickness T4, which is the thickness of the substrate measured at a distance of 4 μm from the tip, has a thickness between 1.40 μm and 1.70 μm; a second thickness T200, which is the thickness of the substrate measured at a distance of 200 μm from the tip, has a thickness between 56.50 μm and 64.12 μm; and a ratio (T4/T200) of the first thickness T4 to the second thickness T200 has a value between 0.022 and 0.030.

Other details of the present disclosure will be described in the detailed description and the drawings below.

According to the embodiments of the present disclosure, at least the following effects may be provided.

It may be possible to secure a razor blade having both lower cutting force and better bending durability compared to a conventional razor blade.

It may be possible to secure a razor blade providing improved shaving performance and enhanced shaving feeling compared to a conventional razor blade.

It may be possible to secure a razor blade with better adhesion between a substrate and a coating layer.

The effects of the present disclosure are not limited to those described above, and other diverse effects are described herein.

### BRIEF DESCRIPTION OF THE DRAWINGS

FIG. 1 is a view of a schematic profile of a part of a razor blade according to an embodiment of the present disclosure.

FIG. 2 is a view for describing a cutting force SHCF.

FIG. 3 is a view for describing the moment of area of the razor blade.

FIG. 4 is an enlarged image of a portion of one surface of a cutting edge of the razor blade according to an embodiment of the present disclosure.

FIG. 5 is a view for describing abraded scratches formed on one surface of the cutting edge of the razor blade according to an embodiment of the present disclosure.

FIG. 6 is a view for describing surface roughness of one surface of the cutting edge of the razor blade according to an embodiment of the present disclosure.

FIG. 7 is a view of a schematic profile of a portion of a conventional razor blade.

### DETAILED DESCRIPTION

As a cutting edge of a razor blade becomes thinner, the cutting force of the razor blade becomes lower. The cutting force means the force required for a razor blade to cut a single strand of hair. Accordingly, as the cutting edge of the razor blade becomes thinner, less force is required to cut hair. However, when the cutting edge is excessively thin, the razor blade is prone to bending while cutting hair, which decreases the bending durability of the blade.

Therefore, an optimized design of a razor blade to secure both bending durability and cutting force thereof is required.

The advantages and characteristics of the present disclosure, and methods of achieving them will be clearly understood with reference to the embodiments described below in detail with the accompanying drawings. However, the present disclosure is not limited to the embodiments disclosed below and may be implemented in a variety of forms, the embodiments are merely intended to complete the present disclosure and to allow a person having ordinary skills in the art to fully understand the scope of the present disclosure, and the present disclosure is defined only by the scope of the claims.

In addition, the embodiments described in this specification will be described with reference to cross-sectional views and/or schematic views, which are ideal exemplary views of the present disclosure. Therefore, the shapes in the exemplary views may be modified due to manufacturing techniques and/or tolerances. Furthermore, components in each drawing of the present disclosure may be shown somewhat enlarged or reduced in consideration of convenience of description. The same reference numbers refer to the same components throughout the specification.

Hereinafter, the present disclosure will be described with reference to the drawings for describing a razor blade according to an embodiment of the present disclosure.

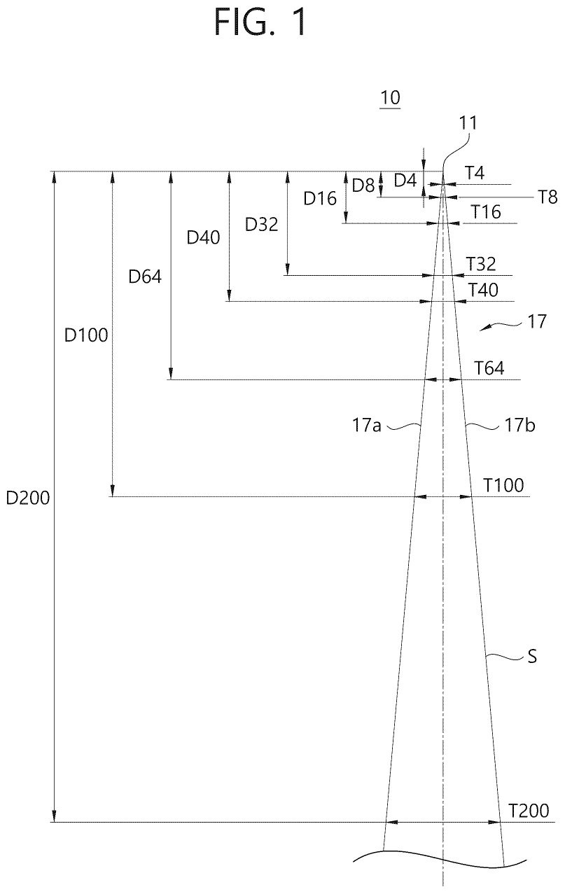

FIG. 1 is a view of a schematic profile of a part of a razor blade 10 according to an embodiment of the present disclosure.

Referring to FIG. 1, the razor blade 10 may include a substrate S having a cutting edge 17 on which a sharp tip 11 is formed.

The substrate S may be made of any one of stainless steel, carbon steel, and ceramic, but the present disclosure is not limited thereto.

Both side surfaces 17a and 17b of the cutting edge 17 may include a plurality of facets formed by an abrading wheel. The detailed description of this will be provided below.

In the case of the razor blade according to an embodiment of the present disclosure, compared to a conventional razor blade, the cutting force required to cut hair may be reduced, the bending durability for preventing bending of the razor blade may be improved, and the durability of the razor blade may be maintained. These technical features will be described below.

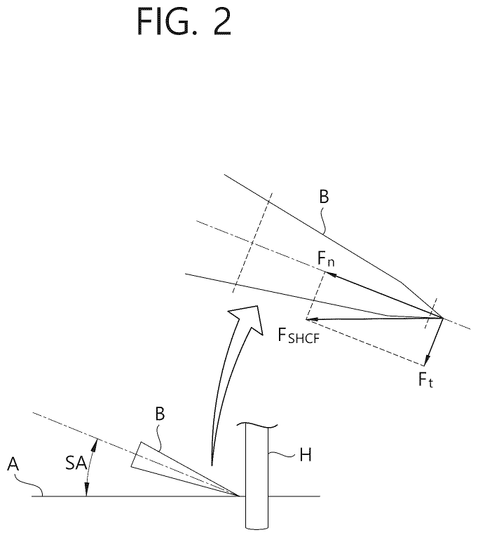

FIG. 2 is a view for describing a cutting force SHCF.

Referring to FIG. 2, in general, a razor blade B may cut hair H by moving while forming a shaving angle SA with respect to the skin surface A.

A Single Hair Cutting Force (SHCF) is the force required for the razor blade B to cut a single strand of hair. Referring to FIG. 2, the cutting force F_{SHCF} may be separated into F_{N} and F_{T} perpendicular to each other. F_{N} may be a force acting in the longitudinal direction of the razor blade B, and F_{T} may be a force acting in a direction perpendicular to the F_{N}.

The F_{N} may be supported by a razor cartridge in which the razor blade B is accommodated, but the razor blade B may be bent by the F_{T}.

In the meantime, when the angle of the razor blade B deviates from an intended value due to bending of the razor blade B, it may negatively impact the shaving feeling. For example, when the razor blade B bends upward to move away from the skin A, miss cuts may occur frequently during shaving, making it difficult to achieve a clean shave. Conversely, when the razor blade B bends downward to get closer to the skin A, it may highly irritate the skin A or cause a wound on the skin A.

Therefore, the razor blade B may need to have a high bending durability to prevent bending thereof. The bending durability refers to the degree of resistance to bending of the razor blade B that may occur, and, as the bending durability is high, the razor blade B is less bent.

In the case of the razor blade 10 according to an embodiment of the present disclosure, the thickness T200 at a position relatively far from the tip 11 may be thick, so that it may be possible to improve a bending durability while maintaining a low cutting force. A detailed description thereof will be provided below with reference to FIGS. 1 to 3.

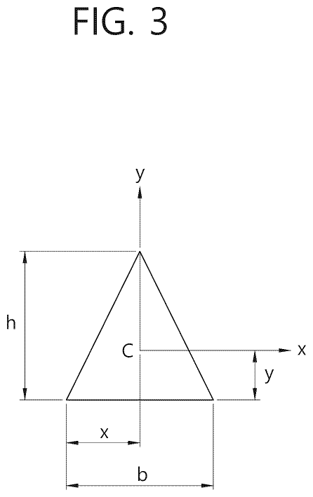

FIG. 3 is a view for describing the moment of area of the razor blade.

Roughly speaking, the razor blade B may have a shape approximately equivalent to an isosceles triangle.

Referring to FIG. 3, b denotes the length of the base of the isosceles triangle, h denotes the height, and, with respect to the centroid C of the isosceles triangle, x=b/2 and y=h/3. Based on this, the second moment of the cross-sectional area of the isosceles triangle in FIG. 3 may be calculated as Ix=b*h³/36, Iy=h*b³/48, and Ixy=0.

As described with reference to FIG. 2, since the razor blade B may be bent by the F_{T}, for the razor blade B, the value of Iy of the second moment of the cross-sectional area may be a value representing the characteristics of the cross-sectional area that resists bending by the F_{T}.

Since Iy=h*b³/48, the value of Iy may be proportional to the cube of b, which represents the length of the base of the isosceles triangle. That is, in the case of the razor blade B, the characteristic of the resistance to bending by the F_{T} may be proportional to the cube of the thickness of the cutting edge.

Referring back to FIG. 1, the thickness T of the substrate S measured at a point away from the tip 11 by a distance D is indicated.

In FIG. 1, a distance of 4 μm from the tip 11 is denoted as D4, and the thickness of the substrate S measured at a point away from the tip 11 by the D4 is denoted as T4. A distance of 8 μm from the tip 11 is denoted as D8, and the thickness of the substrate S measured at a point away from the tip 11 by the D8 is denoted as T8. A distance of 16 μm from the tip 11 is denoted as D16, and the thickness of the substrate S measured at a point away from the tip 11 by the D16 is denoted as T16. A distance of 32 μm from the tip 11 is denoted as D32, and the thickness of the substrate S measured at a point away from the tip 11 by the D32 is denoted as T32. A distance of 40 μm from the tip 11 is denoted as D40, and the thickness of the substrate S measured at a point away from the tip 11 by the D40 is denoted as T40. A distance of 46 μm from the tip 11 is denoted as D64, and the thickness of the substrate S measured at a point away from the tip 11 by the D64 is denoted as T64. A distance of 100 μm from the tip 11 is denoted as D100, and the thickness of the substrate S measured at a point away from the tip 11 by the D100 is denoted as T100. A distance of 200 μm from the tip 11 is denoted as D200, and the thickness of the substrate S measured at a point away from the tip 11 by the D200 is denoted as T200.

According to the above-mentioned rule, it can also be understood how the distances of points not shown in FIG. 1 from the tip 11 and the thicknesses of the substrate S measured at the points are denoted. For example, even though not shown in FIG. 1, a distance of 20 μm from the tip 11 is denoted as D20, and the thickness of the substrate S measured at a point away from the tip 11 by the D20 is denoted as T20.

In addition, as shown in FIG. 1, a distance D from the tip 11 may be measured along the bisecting line of the substrate S.

In the meantime, the razor blade 10 may obliquely approach hair at a predetermined angle with respect to the skin. Furthermore, during shaving, hair may be completely cut when being somewhat laid down by the razor blade. Therefore, the diameter of hair is approximately 100 μm, but the part of the razor blade 10 that is directly in contact with hair to cut the hair during shaving is within the D200 from the tip 11. Accordingly, in order to increase the value of Iy representing the characteristics of the cross-sectional area that resists bending by the F_{T} as described with reference to FIGS. 2 and 3, the T200 must be thick, which may enhance the bending durability of the razor blade 10.

In the meantime, the T4 of the cutting edge 17 may be related to the cutting force of the razor blade 10. In general, the cutting force may be determined at the moment when the tip of the cutting edge 17 cuts in hair, which may be related to the thickness of the T4. Generally, as the T4 becomes thinner, the cutting force may become lower.

Therefore, in the case of the razor blade 10 according to this embodiment of the present disclosure, compared to conventional razor blades, the T4 may be designed to be thinner, and the T200 to be thicker, so that the ratio of the T4 to the T200 (T4/T200) may be smaller than that of the conventional razor blades. As a result, compared to the conventional razor blades, it has a lower cutting force while improving its bending durability.

TABLE 1

| | | Conventional | Range | |
|---|---|---|---|---|
| | | razor Blade | min | max |
| Tip Profile | T4(μm) | 2.15 | 1.40 | 1.70 |
| | T8(μm) | 3.57 | 2.81 | 3.35 |
| | T16(μm) | 6.51 | 5.20 | 6.23 |
| | T32(μm) | 12.26 | 9.75 | 11.75 |
| | T40(μm) | 14.57 | 10.80 | 14.12 |
| | T64(μm) | 22.51 | 17.80 | 22.02 |
| | T100(μm) | 31.96 | 29.00 | 34.14 |
| | T200(μm) | 60.94 | 56.50 | 64.12 |
| Ratio | T4/T200 | 0.035 | 0.022 | 0.030 |

| Change in SHCF (gf) compared to | — | −10% |
|---|---|---|
| conventional razor blade | | |

As shown in Table 1 above, the experiment in which the T4 of the razor blade 10 according to the embodiment is thinner and the ratio of the T4 to the T200 (T4/T200) is smaller compared to the conventional razor blade shows that the cutting force of the razor blade 10 according to the embodiment was reduced by 10% compared to the conventional razor blade.

TABLE 2

| | | Range | |
|---|---|---|---|
| | | min | max |
| Tip Profile | T4(μm) | 1.40 | 1.70 |
| | T5(μm) | 1.60 | 2.20 |
| | T8(μm) | 2.81 | 3.42 |
| | T16(μm) | 5.20 | 6.23 |
| | T20(μm) | 6.30 | 7.30 |
| | T40(μm) | 10.80 | 14.12 |
| | T100(μm) | 29.00 | 34.14 |
| | T200(μm) | 56.50 | 64.12 |
| | T250(μm) | 67.67 | 78.11 |
| Ratio | T4/T8 | 0.409 | 0.605 |
| | T4/T16 | 0.225 | 0.327 |
| | T4/T20 | 0.192 | 0.270 |
| | T4/T40 | 0.099 | 0.157 |
| | T5/T200 | 0.025 | 0.039 |
| | T5/T250 | 0.020 | 0.033 |
| | T4/T100 | 0.041 | 0.059 |
| | T8/T200 | 0.044 | 0.061 |
| | T4/T200 | 0.022 | 0.030 |
| | T4/T250 | 0.018 | 0.025 |

Table 2 shows the details of the tip profile and the ratio of thickness of the razor blade 10 according to an embodiment of the present disclosure. Hereinafter, a plurality of facets formed on at least one of the both side surfaces 17a and 17b of the cutting edge 17 of the razor blade 10 according to an embodiment of the present disclosure will be described.

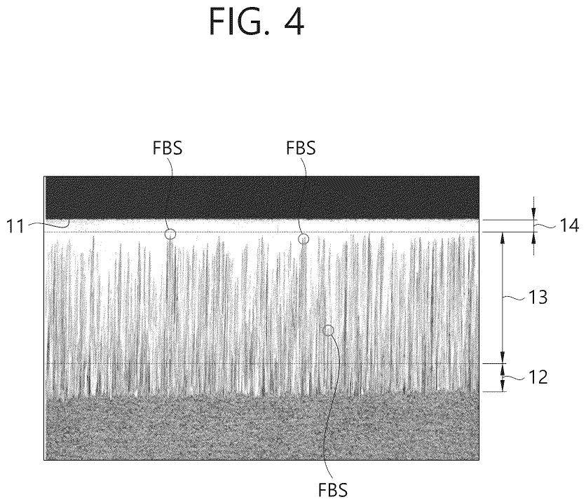

FIG. 4 is an enlarged image of a portion of one surface 17a or 17b of the cutting edge 17 of the razor blade 10 according to an embodiment of the present disclosure.

Referring to FIG. 4, the one surface 17a or 17b of the cutting edge 17 of the razor blade 10 may include a first facet region 12 and a facet brake region 13. Depending on the embodiments, the one surface 17a or 17b of the cutting edge 17 of the razor blade 10 may further include a second facet region 14.

In FIG. 4, a first facet is represented as a dark abraded scratch, and a second facet is represented as a bright abraded scratch. Referring to FIG. 4, a plurality of second facets may be formed between the tip 11 and a plurality of first facets.

The facet brake region 13 may be a region in which the plurality of first facets and the plurality of second facets coexist. Facet brake spots FBS where the first facet and the second facet intersect may be irregularly distributed within the facet brake region 13. Although only some of the facet brake spots FBS are shown in FIG. 4, there may be the facet brake spots FBS almost all over the area above the dark abraded scratches in FIG. 4.

The first facet region 12 may be a region including the plurality of first facets but no second facets.

The second facet region 14 may be a region including the plurality of second facets but no first facets.

The facet brake region 13 may be formed within a distance D200 from the tip 11.

In the case of the embodiment in which the second facet region 14 exists, the second facet region 14 may be formed within a distance D16 from the tip 11, and the facet brake region 13 may be formed within a distance D200 from the second facet region 14 or between a distance D16 and a distance D200.

The first facet region 12 may be formed within a distance D280 from the facet brake region 13.

The first facet may be formed by a first abrading wheel using Cubic Boron Nitride (CBN) having relatively coarse and sparse grains. The second facet may be formed by a second abrading wheel having relatively fine and dense grains, which is different from the first abrading wheel.

In the case of the razor blade 10 according to this embodiment, the plurality of first facets may be formed on both side surfaces 17a and 17b or one side surface of the substrate S by the first abrading wheel. Thereafter, on a first abraded surface on which the plurality of first facets are formed, the plurality of second facets may be formed within a distance D200 from the tip 11 by the second abrading wheel.

Facet brake spots FBS may be discontinuously formed at the point where a first abrading process using the first abrading wheel and a second abrading process using the second abrading wheel intersect, forming the facet brake region 13.

When different facets are formed by performing the second abrading process on a first abrading surface on which a first facet is formed after performing the first abrading process for forming the first facet, the first facet and a second facet may respectively form a predetermined angle. In addition, based on the bisector of the substrate S, the angle of the second facet may be greater than that of the first facet.

Therefore, in the case of a razor blade in which the facet brake spots FBS where the first facet and the second facet intersect are continuously formed, during shaving, only the second facet is in contact with hair and involved in cutting the hair, but the first facet can hardly be in contact with the hair and is thus not involved in cutting the hair. In this case, while the razor blade is cutting the hair, a cutting edge cannot continuously spread the hair, resulting in abnormal cutting of the hair.

However, in the case of the razor blade 10 according to this embodiment, the facet brake spots FBS where the first facet and the second facet intersect may be discontinuously formed within a distance D200 from the tip 11. Furthermore, as described above, the region of the razor blade 10 within the distance D200 from the tip 11 may be the region where the razor blade 10 is directly in contact with hair during the shaving process.

In the case of the razor blade 10 according to this embodiment, even though the first facet and the second facet may form a predetermined angle, since the facet brake spots FBS may be discontinuously formed within the distance D200 from the tip 11, in the process of cutting hair, the plurality of first facets and the plurality of second facets may remain in contact with the hair, and the cutting edge may continuously spread the hair.

More specifically, because the first facets and the second facets may coexist on a line parallel to the tip 11 within the distance D200 from the tip 11. Therefore, the second facets on the same line parallel to the tip 11 may be in contact with hair even when some of the first facets are not in contact with the hair. As a result, during the process of cutting the hair, the plurality of first facets and the plurality of second facets may remain in contact with the hair.

As a result, the performance of cutting hair may be improved, and a cleaner shave and a smoother feeling of shaving may be provided.

There may be a difference of 0 to 2 degrees between the angle between the central axis of the substrate S passing through the tip 11 and the first facet (hereinafter, referred to as “a first facet angle”) and the angle between the central axis of the substrate S passing through the tip 11 and the second facet (hereinafter, referred to as “a second facet angle”). The difference between the first facet angle and the second facet angle may be 0 to 1 degree, for example, 0 to 0.5 degree.

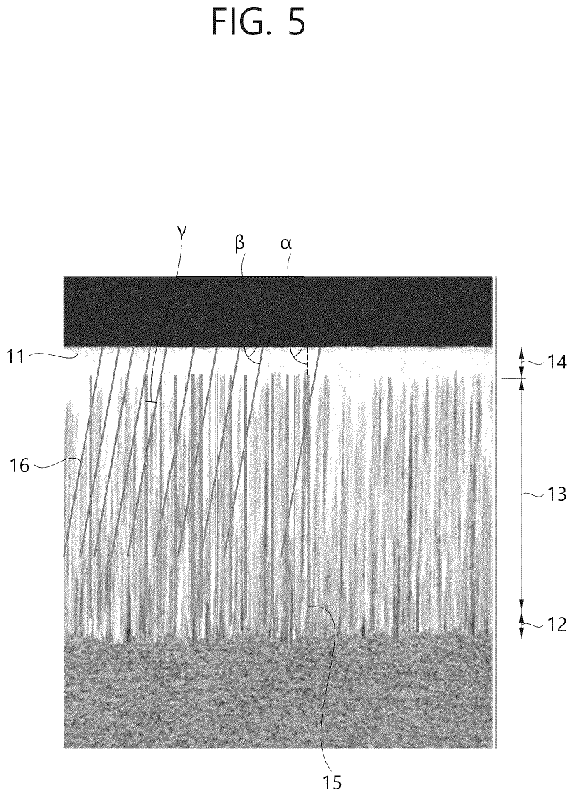

FIG. 5 is a view for describing abraded scratches formed on one surface of the cutting edge of the razor blade according to an embodiment of the present disclosure.

Referring to FIG. 5, a first abraded scratch 15 forming the first facet and a second abraded scratch 16 forming the second facet may not be parallel to each other. That is, the first abraded scratch 15 and the second abraded scratch 16 may intersect to form respective predetermined angles γ within the facet brake region 13.

The first abraded scratch 15 and the second abraded scratch 16 may intersect at an angle γ of less than 10 degrees.

An angle α between the first abraded scratch 15 forming the first facet and a line extended from the tip 11 may be 88 to 90 degrees. The angle α may be 88.5 to 89.8 degrees, for example, 89 to 89.5 degrees.

An angle β between the second abraded scratch 16 forming the second facet and the line extended from the tip 11 may be 80 to 90 degrees. The angle θ may be 82 to 87 degrees, for example, 84 to 85 degrees.

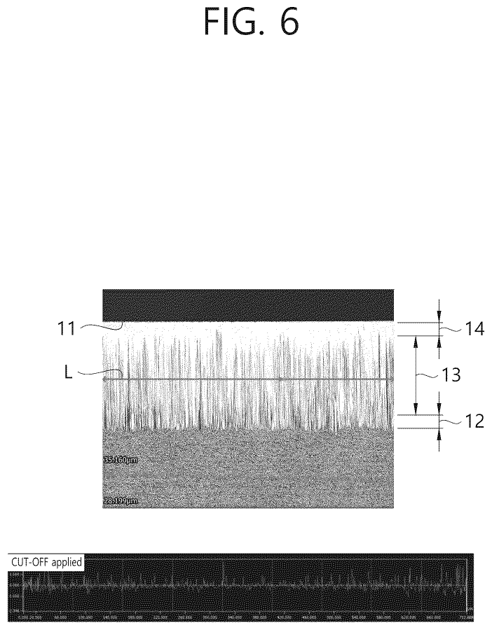

FIG. 6 is a view for describing the surface roughness of one surface of the cutting edge of the razor blade according to an embodiment of the present disclosure.

The surface roughness means the roughness of the surface.

Although there are a range of methods of measuring surface roughness, in the present disclosure, a method of measuring surface roughness on a measurement line L parallel to the line extended from the tip 11 was used, and the center line average calculation method (Ra) was used within a reference length (0.08 mm).

The graph in FIG. 6 shows the surface roughness measured in the facet brake region 13.

The surface roughness measured in the facet brake region 13 was 150 nm to 280 nm, the surface roughness measured in the first facet region 12 was 300 nm to 400 nm, and the surface roughness measured in the second facet region 14 was 1 nm to 50 nm.

The facet brake region 13 and the first facet region 12 may be distinguished by surface roughness. For example, a region having a surface roughness of 300 nm or more may be classified as the first facet region 12, and a region having a surface roughness of 300 nm or less may be classified as the facet brake region 13.

In addition, the facet brake region 13 and the second facet region 14 may be distinguished by surface roughness. For example, a region having a surface roughness of 100 nm or more may be classified as the facet brake region 13, and a region having a surface roughness of 100 nm or less may be classified as the second facet region 14. Alternatively, a region having a surface roughness of 150 nm or more may be classified as the facet brake region 13, and a region having a surface roughness of 150 nm or less may be classified as the second facet region 14. A region having a surface roughness of 50 nm or more may be classified as the facet brake region 13, and a region having a surface roughness of 50 nm or less may be classified as the second facet region 14.

The substrate S according to this embodiment may be made of martensitic stainless, and Mo may be added thereto. In addition, the sub-zero treatment may be performed therefore, and the carbide by Fein may be included therein.

The razor blade 10 according to this embodiment may include at least one metal coating layer and a lubrication coating layer laminated on top of the metal coating layer on the substrate S. The metal coating layer may include one or more of CrB, CrC, and DLC. The lubrication coating layer may include polytetrafluoroethylene (PTFE). However, the present disclosure is not limited thereto.

The metal coating layer may supplement the rigidity of the substrate S, and the lubrication coating layer may reduce the frictional force between the razor blade and the skin.

An adhesive coating layer based on at least one of Cr, CrB, and CrC may be further included between the metal coating layer and the lubrication coating layer. The adhesive coating layer may enhance adhesion between the metal coating layer and the lubrication coating layer.

The thickness of the metal coating layer may be 180 nm or less, the thickness of the lubrication coating layer may be 5 nm to 400 nm, and the thickness of the adhesive coating layer may be 5 nm to 30 nm.

The radius of the tip of the razor blade 10 including the tip or the coating layers of the substrate S may be 50 to 500 Å.

In the meantime, when the level of the surface roughness of the substrate is excessively low, the adhesion between the metal coating layer and the substrate may be low so that the substrate and the metal coating layer may be separated from each other. In this case, it may be difficult to form the metal coating layer having a thickness of more than 100 nm to 200 nm.

In contrast, when the level of the surface roughness of the substrate is excessively high, the thickness of the metal coating layer may be changed by curves present on the surface of the substrate. In addition, when the curves present on the surface of the substrate are filled with the metal coating layer, air voids may be formed due to the growth rate of the metal coating layer. When the air voids are formed, the substrate may be corroded because it may be exposed to the outside, and the adhesion between the metal coating layer and the substrate may be deteriorated due to the air voids so that the substrate and the metal coating layer may be separated from each other.

As described above, the first abraded scratch 15 and the second abraded scratch 16 may be formed on the surface of the substrate S, and the regions 12, 13, and 14 may have their respect surface roughness as described above. As a result, the surface area of the substrate S of the razor blade 10 according to this embodiment may have an expended surface area of the substrate S, which leads to a strong adhesion between the substrate S and the metal coating layer.

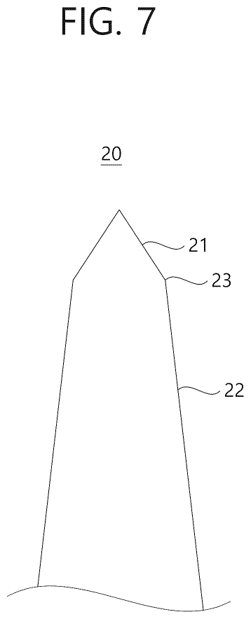

FIG. 7 is a view of a schematic profile of a portion of a conventional razor blade 20.

Referring to FIG. 7, in the case of the conventional razor blade 20 may be clearly differentiated by a boundary 23 between a first facet 21 and a second facet 22. That is, in the case of the conventional razor blade 20, the boundary 23 distinguishing the first facet 21 and the second facet 22 may be formed in a linear shape.

After performing the first abrading process for forming the first facet 21, the second facet 22 may be formed by carrying out the second abrading process on the first abraded surface on which the first facet 21 has been formed. Accordingly, the first facet 21 and the second facet 22 may form an obtuse angle at the boundary 23 so that the razor blade 20 may have an outwardly convex profile.

However, in the case of the razor blade 10 according to the above-mentioned embodiment of the present disclosure, compared to the conventional razor blade 20, T4 may be formed smaller, and T200 may be formed larger. In order for the razor blade 10 to have such a profile, the T4 and the T200 must be in different facet regions, and, compared to the conventional razor blade 20, the angle between the first facet and the second facet should be closer to 180 degrees (see FIG. 1). The profile cannot be obtained by a conventional abrading process in which the first facet 21 and the second facet 22 are clearly distinguished.

As described above, the razor blade 10 according to the embodiment of the present disclosure may have a profile in which the region where the plurality of first facets exist and the region where the plurality of second facets exist are smoothly connected as a whole by an abrading process of forming the facet brake region 13 in which some of the plurality of first facets overlaps some of the plurality of second facets.

A person having ordinary skills in the art to which the present disclosure pertains may be able to understand that the present disclosure can be implemented in other specific forms without changing its technology or essential features. Therefore, it should be understood that the above-described embodiments are illustrative in all respects and not limiting. The scope of the present disclosure is defined by the following claims rather than the detailed description above, and all changes or modifications derived from the meaning and scope of the claims and their equivalent concepts should be construed as being included in the scope of the present disclosure.

What is claimed is:

1. A razor blade comprising:
a substrate having a cutting edge formed at a tip, the substrate comprising:
a plurality of first facets;
a plurality of second facets formed between the tip and the plurality of first facets;
a facet brake region having facet brake spots where the plurality of first facets and the plurality of second facets intersect; and
a first facet region including the plurality of first facets and not including the plurality of second facets,
wherein a first thickness T4, defined as a thickness of the substrate measured at a distance of 4 μm from the tip, is between 1.40 μm and 1.70 μm,
wherein a second thickness T200, defined as a thickness of the substrate measured at a distance of 200 μm from the tip, is between 56.50 μm and 64.12 μm, and
wherein a ratio (T4/T200) of the first thickness T4 to the second thickness T200 is between 0.022 and 0.030.

2. The razor blade of claim 1, wherein the facet brake region is formed within a distance of 200 μm from the tip.

3. The razor blade of claim 1, wherein the facet brake region is formed at a distance of 16 μm or more from the tip.

4. The razor blade of claim 1, comprising a second facet region including the plurality of second facets and not including the plurality of first facets.

5. The shaving razor of claim 1, wherein there is a difference of 0 to 2 degrees between an angle between a central axis of the substrate passing through the tip and the first facet, and an angle between the central axis and the second facet.

6. The razor blade of claim 1, wherein there is a difference of 0 degree to 1 degree between an angle between a central axis of the substrate passing through the tip and the first facet, and an angle between the central axis and the second facet.

7. The razor blade of claim 1, wherein an angle of an abraded scratch of the first facet with respect to the tip is 88 degrees to 90 degrees.

8. The razor blade of claim 1, wherein an angle of an abraded scratch of the second facet with respect to the tip is 80 degrees to 90 degrees.

9. The razor blade of claim 1, wherein an angle of an abraded scratch of the second facet with respect to the tip is 82 degrees to 87 degrees.

10. The razor blade of claim 1, wherein an angle of an abraded scratch of the second facet with respect to the tip is 84 degrees to 85 degrees.

11. The razor blade of claim 1, wherein an abraded scratch of the first facet and an abraded scratch of the second facet intersect in the facet brake region, and wherein the abraded scratch of the first facet and the abraded scratch of the second facet intersect at an angle of less than 10 degrees.

12. The razor blade of claim 1, wherein a surface roughness value of the facet brake region is lower than a surface roughness value of the first facet region.

13. The razor blade of claim 12, wherein the surface roughness value (Ra) of the facet brake region is 300 nm or less, and wherein the surface roughness value (Ra) of the first facet region is between 300 nm and 400 nm.

14. The razor blade of claim 13, wherein the surface roughness value (Ra) of the facet brake region is between 150 nm and 280 nm.

15. A razor blade comprising:
a substrate having a cutting edge formed at a tip, the substrate comprising:
a first facet region including a plurality of first facets formed by first abraded scratches;
a plurality of second facets formed by second abraded scratches; and
a facet brake region where the first abraded scratches and the second abraded scratches coexist,
wherein a first thickness T4, defined as a thickness of the substrate measured at a distance of 4 μm from the tip, has a thickness between 1.40 μm and 1.70 μm,
wherein a second thickness T200, defined as a thickness of the substrate measured at a distance of 200 μm from the tip, has a thickness between 56.50 μm and 64.12 μm, and
wherein a ratio (T4/T200) of the first thickness T4 to the second thickness T200 has a value between 0.022 and 0.030.

16. The razor blade of claim 15, wherein the facet brake region is formed between the cutting edge and the first facet region.
